(19) United States
(12) Patent Application Publication
(10) Pub. No.: US 2007/0028308 A1
(43) Pub. Date: Feb. 1, 2007

(54) Decoding apparatus

(76) Inventors: Kosuke Nishio, Osaka (JP); Takashi Katayama, Osaka (JP); Tomoki Ogawa, Osaka (JP)

Correspondence Address: MCDERMOTT WILL & EMERY LLP, 600 13TH STREET, N.W., WASHINGTON, DC, 20005-3096, US

(21) Appl. No.: 11/493,527

(22) Filed: Jul. 27, 2006

(30) Foreign Application Priority Data
Jul. 29, 2005 (JP) 2005-221799

(51) Int. Cl. H04L 9/32

(52) U.S. Cl. 726/27

(57) ABSTRACT

A decoding apparatus includes: a decoding section for decoding input encoded video data and input encoded audio data; an output section for outputting video data and audio data decoded by the decoding section, in accordance with an output control signal; a decoding control section for controlling the decoding section in such a manner that in a case in which copyright information on contents containing the encoded video data and the encoded audio data is not detected, if there is a playback request, the decoding section performs decoding process for performing playback at normal speed, and if there is no playback request, the decoding section performs decoding process for detecting the copyright information at high speed; a copyright information detection section for detecting the copyright information from the audio data decoded by the decoding section; and an output control section for determining, based on the detected copyright information, whether or not the contents are authorized contents and outputting the output control signal.

### CROSS-REFERENCE TO RELATED APPLICATIONS

The disclosure of Japanese Patent Application No. 2006-195273 filed on Jul. 18, 2006 including specification, drawings and claims is incorporated herein by reference in its entirety.

### BACKGROUND OF THE INVENTION

The present invention relates to a decoding apparatus for decoding encoded video and audio data, and particularly relates to copyright protection technology.

The amount of information in digitized video and audio data is usually reduced by high-efficiency coding process and then the resultant data is multiplexed so as to be recorded on a recording medium or transmitted. The major examples of the recording medium include a DVD (Digital Versatile Disc). The major examples of the transmission include distribution via digital television broadcast or the Internet.

Video data is encoded mainly according to the MPEG-2 (Moving Picture Experts Group-2) standard, the MPEG-4 standard, or the like, while audio data is encoded mainly in accordance with Dolby Digital, DTS (Digital Theater Systems), MPEG Audio, PCM (Pulse Code Modulation), or the like.

Audio data encoded according to these encoding methods will be hereinafter referred to as “encoded audio data”. In many cases, multiple channels of audio data are encoded as encoded audio data.

If video and audio are converted into digital data, they can be recorded or transmitted more conveniently, while replication thereof without degradation becomes possible, leading to the problem of copyright infringement. In order to deal with this problem, a technique for embedding copyright information in video and audio data has been developed. Although detailed explanation of this technique will be omitted herein, this kind of technique has already been employed in DVD-Audio and the like, for example.

To detect copyright information, it is required to decode video data and audio data and to perform detection process. Such detection process needs to be performed even during high speed playback, and Japanese Laid-Open Publication No. 2003-66996, for example, discloses a technique for detecting copyright information, while dubbing of a compact disc (CD) is performed at high speed.

In CDs and DVD-Audios, audio data has been important copyrighted material. In the future, however, copyright protection may be provided for contents that contain a movie or other moving image data as well, by using copyright information embedded in audio data. In that case, not only the video data but also the audio data must be decoded and the copyright information needs to be detected. This causes a problem in that the amount of computation is increased significantly and high computing capability is required particularly during high speed playback.

In some cases, during high speed playback, audio data decoding process is omitted to reduce the amount of computation and the amount of data transfer. In those cases, however, there is a problem in that copyright information embedded in the audio data cannot be detected.

### SUMMARY OF THE INVENTION

It is therefore an object of the present invention to perform processing of copyright information without requiring high computing capability.

A decoding apparatus according to the present invention performs decoding process for performing normal speed playback or decoding process for performing high speed detection of copyright information depending upon the presence/absence of a playback request, so as to detect the copyright information on contents and control the output of the decoded result according to the detected copyright information.

More specifically, an inventive decoding apparatus includes: a decoding section for decoding input encoded video data and input encoded audio data; an output section for outputting video data and audio data decoded by the decoding section, in accordance with an output control signal; a decoding control section for controlling the decoding section in such a manner that in a case in which copyright information on contents containing the encoded video data and the encoded audio data is not detected, if there is a playback request, the decoding section performs decoding process for performing playback at normal speed, and if there is no playback request, the decoding section performs decoding process for detecting the copyright information at high speed, the decoding process for detecting the copyright information at high speed being partially omitted decoding process for performing playback at normal speed; a copyright information detection section for detecting the copyright information from the audio data decoded by the decoding section and outputting the detected copyright information; and an output control section for determining, based on the copyright information detected by the copyright information detection section, whether or not the contents are authorized contents and outputting the output control signal, wherein when the contents have been determined to be authorized contents, the output control section outputs the output control signal so as to make the output section produce an output, and when the contents have been determined to be unauthorized contents, the output control section outputs the output control signal so as to make the output section stop producing an output.

In the inventive decoding apparatus, since the decoding process for performing playback at normal speed or the decoding process for detecting the copyright information at high speed is performed to detect the copyright information, the copyright information can be obtained without requiring high processing capability. In addition, high speed playback performed at higher speed than normal speed is carried out only after the copyright information is obtained. Therefore, decoding process for obtaining the copyright information does not have to be carried out during such high speed playback. This enables output control according to the copyright information to be performed without requiring high processing capability.

According to the present invention, processing capability required for copyright information processing can be lowered. Also, even in cases where audio data is not decoded during high speed playback or the like, it is also possible to protect a copyright on contents.

### BRIEF DESCRIPTION OF THE DRAWINGS

FIG. 1 is a block diagram of a decoding apparatus according to a first embodiment of the present invention.

FIG. 2 is a flowchart indicating a process flow for obtaining copyright information in the decoding apparatus of FIG. 1.

FIG. 3 is a block diagram of a decoding apparatus according to a second embodiment of the present invention.

### DETAILED DESCRIPTION OF THE INVENTION

Hereinafter, embodiments of the present invention will be described with reference to the accompanying drawings.

### First Embodiment

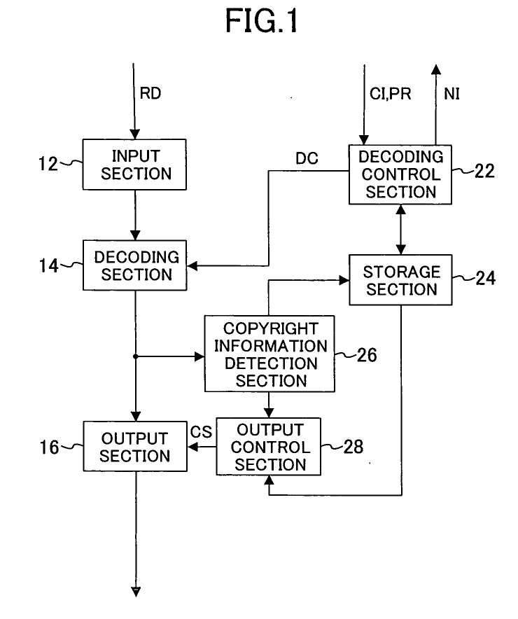

FIG. 1 is a block diagram of a decoding apparatus according to a first embodiment of the present invention. The decoding apparatus of FIG. 1 includes an input section 12, a decoding section 14, an output section 16, a decoding control section 22, a storage section 24, a copyright information detection section 26, and an output control section 28. The decoding apparatus of FIG. 1 is used in a DVD player with audio watermark detection capability, for example.

Data RD containing contents read from a DVD, for example, is input into the input section 12. In the data RD, encoded video data and encoded audio data have been multiplexed together. In the encoded audio data in the data RD, copyright information on the contents is embedded as a watermark. The input section 12 divides the input data RD into the encoded video data and the encoded audio data and outputs the obtained encoded video and audio data to the decoding section 14.

The decoding section 14 decodes the encoded video and audio data according to the MPEG-2 standard or the like in accordance with a decoding control signal DC output from the decoding control section 22 and outputs the obtained decoded video and audio data to the output section 16 and to the copyright information detection section 26. The output section 16 outputs the decoded video and audio data in accordance with an output control signal CS output from the output control section 28.

According to an externally input playback request signal PR, externally input information CI on the contents, and information stored in the storage section 24, the decoding control section 22 outputs the decoding control signal DC to control the decoding process of the decoding section 14, while externally outputting the state of the decoding process as notification information NI. The copyright information detection section 26 detects the copyright information embedded in the decoded audio data and outputs the detected copyright information to the storage section 24 and to the output control section 28.

The storage section 24 stores therein the copyright information detected by the copyright information detection section 26 and outputs the stored copyright information to the output control section 28 according to the output of the decoding control section 22. In accordance with the outputs of the copyright information detection section 26 and storage section 24, the output control section 28 generates and outputs the output control signal CS for controlling the output process of the output section 16. The output control section 28 determines, based on the detected copyright information, whether or not the contents being processed are authorized contents. When the output control section 28 has determined that the contents being processed are authorized contents, the output control section 28 outputs the output control signal CS so as to make the output section 16 produce an output. When the output control section 28 has determined that the contents being processed are unauthorized contents, the output control section 28 outputs the output control signal CS so as to make the output section 16 stop producing an output.

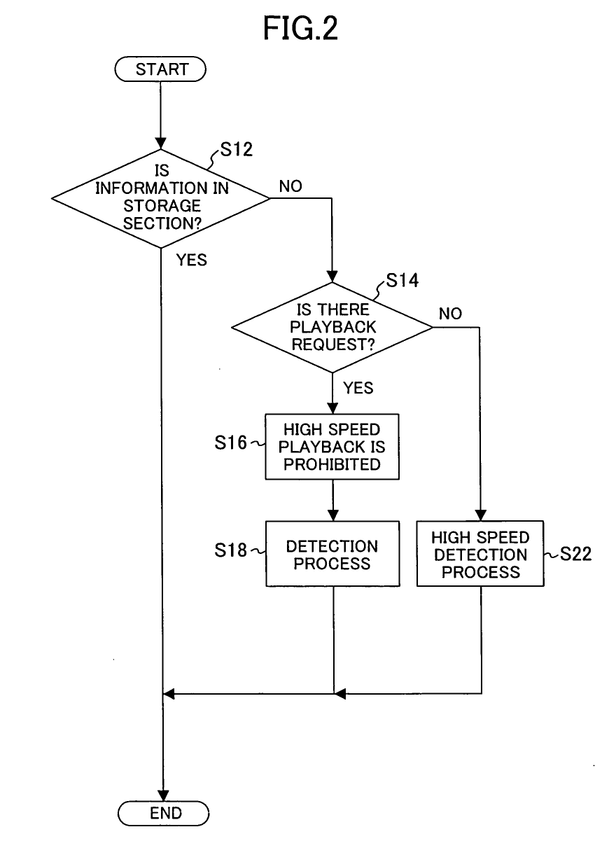

FIG. 2 is a flowchart indicating a process flow for obtaining copyright information in the decoding apparatus of FIG. 1. With reference to FIG. 2, specific operation of the decoding apparatus of FIG. 1 will be described.

First, data RD containing contents to be played back is input into the input section 12, and information CI on the contents is input into the decoding control section 22. The information CI on the contents is disk information, program information, management information specific to the decoding apparatus, or the like, and may be any information so long as the contents can be identified by the information.

In a step S12, the decoding control section 22 determines whether or not the information CI on the contents to be played back and copyright information corresponding to the contents are stored in the storage section 24. In this step, it is determined whether or not copyright information on data about at least one of one or more audio channels contained in the contents to be played back is stored. When the information on the contents to be played back and the copyright information corresponding to the contents are stored in the storage section 24, the process is terminated, and when they are not stored, the procedure goes to a step S14.

In the step S14, the decoding control section 22 determines the presence or absence of a playback request according to an externally input playback request signal PR. When there is a playback request, the procedure goes to a step S16. When there is no playback request, the procedure goes to a step S22.

In the step S16, the decoding control section 22 outputs to the decoding section 14 a normal decoding request signal as a decoding control signal DC. The decoding control section 22 prohibits high speed playback and externally makes a notification of the prohibition by outputting notification information NI. The high speed playback is playback performed at higher speed than normal speed. For example, when data encoded according to the MPEG-2 standard is played back, playback for playing back only I pictures, playback for playing back only I and P pictures, and the like are high speed playback.

In a step S18, normal detection process is performed. In this step, video data and audio data are input into the input section 12 at normal speed. Upon receipt of the normal decoding request signal, the decoding section 14 performs normal decoding. That is, the decoding section 14 performs decoding for playing back the video and audio data at normal speed. The copyright information detection section 26 detects copyright information embedded in the decoded audio data. In this manner, the copyright information detection section 26 detects the copyright information during the normal speed playback, and when the playback is complete, the information on the contents to be played back and the copyright information corresponding to the contents are stored in the storage section 24.

In the step S22, high speed detection process is performed. In this step, the decoding control section 22 outputs to the decoding section 14 a high-speed detection decoding request signal as the decoding control signal DC. Upon receipt of the high-speed detection decoding request signal, the decoding section 14 performs decoding process for high speed detection.

Now, a description will be made of the decoding process for high speed detection. This process is decoding process for detecting copyright information at higher speed than normal playback speed, and part of the decoding process is omitted so as to perform the decoding process in a shorter time. For example, in a case where no video data is necessary to detect copyright information, decoding of encoded video data is omitted.

And in a case where the number of channels of audio data necessary for copyright information detection is smaller than the number of channels of audio data contained in the contents, the decoding section 14 does not decode all of the multiple channels of data existing as the encoded audio data but decodes only one or more of the multiple channels of data that are necessary for the detection. This allows part of the decoding process to be omitted, thereby reducing the amount of computation.

In the step S22, if a requirement with respect to sampling frequency necessary for the copyright information detection is satisfied, the decoding section 14 omits part of the decoding process for decoding the encoded audio data so as to obtain audio data whose sampling frequency is lower than that of audio data obtained when normal process is performed for the encoded audio data. In that case, the decoding section 14 does not have to operate at high speed, thereby reducing the amount of computation and power consumption.

Also, in the step S22, if the contents to be played back contain multiple types of audio data encoded by different encoding methods, the decoding section 14 may select one of the multiple types of encoded audio data encoded by a method that allows the amount of computation required for the decoding to be minimized and then decode the selected data. For example, the amount of computation required to decode uncompressed encoded audio data, such as PCM data, is smaller than that required to decode compressed encoded audio data, such as Dolby Digital data. Therefore, the decoding section 14 selects uncompressed encoded audio data.

In the step S22, the copyright information detection section 26 receives the audio data output from the decoding section 14 and detects copyright information. The copyright information detection section 26 performs the detection for the entire contents to be played back and makes the storage section 24 store the detection results. When this high speed detection process is complete, the information on the contents to be played back and the copyright information corresponding to the contents are stored in the storage section 24. If the high speed detection process has been completed before playback is started, normal speed playback or high speed playback can be performed thereafter without detecting copyright information for the contents.

However, if a playback request is made from outside before the completion of the detection for the entire contents, the decoding control section 22 outputs a normal decoding request signal to the decoding section 14. At this time, the decoding control section 22 prohibits high speed playback, such as playback for playing back only I pictures and playback for playing back only I and P pictures, and externally makes a notification about the prohibition. That is, the same process as those in the steps S16 and S18 is performed.

When it has been determined in the step S12 that the information on the contents to be played back and the copyright information corresponding to the contents are stored in the storage section 24, or when those information sets have been stored as a result of the processes in the above-described steps S14, S16, S18, and S22, the next process is performed during playback such as high speed playback. To be specific, when the output control section 28 has determined, based on the information stored in the storage section 24, that the contents to be played back are authorized contents, the output control section 28 outputs as the output control signal CS to the output section 16 a signal for allowing the output section 16 to produce an output. On the other hand, when the output control section 28 has determined that the contents to be played back are not authorized contents, the output control section 28 outputs as the output control signal CS to the output section 16 a signal for prohibiting the output section 16 from producing an output.

As described above, in the decoding apparatus of FIG. 1, copyright information detection process is carried out with normal speed playback being performed, or copyright information detection process in which part of decoding process is omitted is performed. Therefore, output control in accordance with copyright information can be performed without requiring high processing capability. Furthermore, since high speed playback is performed after copyright information is obtained, it is possible to confirm and protect the copyright on the contents without decoding the audio data during the high speed playback.

Although the output control section 28 and the decoding control section 22 are provided in the foregoing description, these sections may be realized as a single control section.

### Second Embodiment

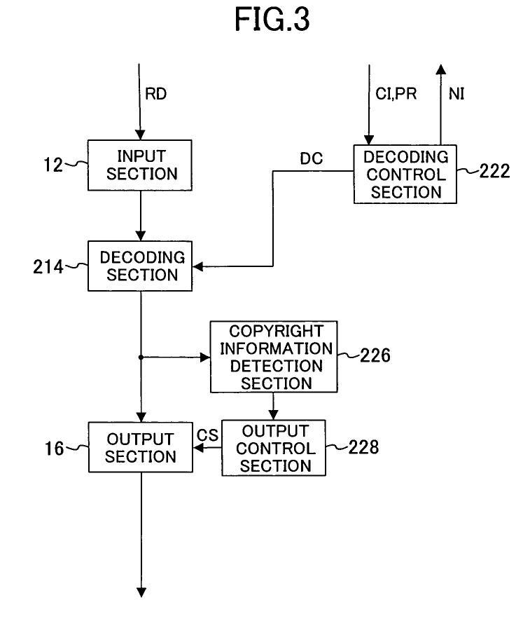

FIG. 3 is a block diagram of a decoding apparatus according to a second embodiment of the present invention. The decoding apparatus of FIG. 3 includes an input section 12, a decoding section 214, an output section 16, a decoding control section 222, a copyright information detection section 226, and an output control section 228. In FIG. 3, the same members as those described with reference to FIG. 1 are identified by the same reference numerals and the description thereof will be omitted herein.

When information CI on contents to be played back is input, the decoding control section 222 outputs to the decoding section 214 a high-speed detection decoding request signal as a decoding control signal DC. Upon receiving the high-speed detection decoding request signal, the decoding section 214 performs high-speed detection decoding process. The high-speed detection decoding process is the same as that described in the first embodiment.

For example, in a case where the number of channels of audio data necessary for copyright information detection is smaller than the number of channels of audio data contained in the contents, the decoding section 214 does not decode all of the multiple channels of data existing as encoded audio data but decodes only one or more of the multiple channels of data that are necessary for the detection. This allows part of the decoding process to be omitted, thereby reducing the amount of computation.

Also, if a requirement with respect to sampling frequency necessary for the copyright information detection is satisfied, the decoding section 214 may omit part of the decoding process for decoding the encoded audio data so as to obtain audio data whose sampling frequency is lower than that of audio data obtained when normal process is performed for the encoded audio data. In that case, the decoding section 214 does not have to operate at high speed, thereby reducing the amount of computation and power consumption.

If the contents to be played back contain multiple types of audio data encoded by different encoding methods, the decoding section 214 may select one of the multiple types of encoded audio data encoded by a method that allows the amount of computation required for the decoding to be minimized and then decode the selected data. For example, the amount of computation required to decode uncompressed encoded audio data, such as PCM data, is smaller than that required to decode compressed encoded audio data, such as Dolby Digital data. Therefore, the decoding section 214 selects uncompressed encoded audio data.

The copyright information detection section 226 receives the audio data output from the decoding section 214 and detects copyright information. The copyright information detection section 226 notifies the output control section 228 of the detection results obtained by performing the detection for the entire contents to be played back.

Thereafter, high speed playback is performed. Since the output control section 228 has already been notified of the copyright information detection results, the output control section 228 may control the output section 16 in accordance with those copyright information detection results when the high speed playback is performed. To be specific, when the output control section 228 has determined, based on the detection results, that the contents to be played back are authorized contents, the output control section 228 outputs as an output control signal CS to the output section 16 a signal for allowing the output section 16 to produce an output. On the other hand, when the output control section 228 has determined that the contents to be played back are not authorized contents, the output control section 228 outputs as the output control signal CS to the output section 16 a signal for prohibiting the output section 16 from producing an output.

In the other respects, the decoding section 214, the decoding control section 222, the copyright information detection section 226, and the output control section 228 are the same as the decoding section 14, the decoding control section 22, the copyright information detection section 26, and the output control section 28 of FIG. 1, respectively, and detailed explanation thereof will be thus omitted herein.

As described above, in the decoding apparatus of FIG. 3, it is also possible to confirm and protect the copyright on the contents without decoding the audio data during high speed playback.

Although the output control section 228 and the decoding control section 222 are provided in the foregoing description, these sections may be realized as a single control section.

In the foregoing embodiments, copyright information detection is performed for the entire input contents. However, when it is only necessary to perform detection for part of the contents, the detection may be carried out only for that necessary part. When it is sufficient that detection is carried out only for a specified length of time, the detection may be performed only for the beginning part of the contents or may be performed with part of the contents being skipped. That is, the decoding sections 14 and 214 may decode encoded audio data only for some periods, in which copyright information detection is performed. It is then possible to shorten the length of time required for the detection.

The decoding sections 14 and 214 may decimate encoded audio data at regular intervals and perform decoding.

Also, in the above-described embodiments, playback is performed, if it is confirmed that copyright information on data about at least one of one or more audio channels contained in the contents to be played back indicates that the contents are authorized ones. For example, the output control section 28 outputs, as the output control signal CS, a signal for prohibiting an output, except when copyright information detected from one of the encoded audio data sets contained in the contents to be played back that has been encoded by at least one encoding method is stored in the storage section 24.

Alternatively, output may be allowed only when audio data whose copyright information has been confirmed to be authorized information is the same as the audio data to be played back. For example, the output control section 28 may output as the output control signal CS a signal for prohibiting an output, when copyright information detected from one of the encoded audio data sets that is to be played back is not stored in the storage section 24. Then, a higher level of copyright protection is provided.

Moreover, although data read from a DVD is processed in the above-described exemplary cases, the present invention is not limited to these cases, but data stored on other recording media, such as other optical disks and hard disks, data read from semiconductor memory, broadcast data, data received over a network, and the like may also be processed.

The above-described processing may be realized not only by hardware but also by software by using a processor. Alternatively, part of the processing may be performed by hardware and the rest may be performed by software.

As described above, the present invention enables copyright information to be processed during high speed playback without requiring high processing capability and is thus effectively applicable to DVD players and the like and, in addition, to other optical disk players, hard disk drive players, semiconductor players, network players, and the like.

What is claimed is:

1. A decoding apparatus, comprising:
a decoding section for decoding input encoded video data and input encoded audio data;
an output section for outputting video data and audio data decoded by the decoding section, in accordance with an output control signal;
a decoding control section for controlling the decoding section in such a manner that in a case in which copyright information on contents containing the encoded video data and the encoded audio data is not detected, if there is a playback request, the decoding section performs decoding process for performing playback at normal speed, and if there is no playback request, the decoding section performs decoding process for detecting the copyright information at high speed, the decoding process for detecting the copyright information at high speed being partially omitted decoding process for performing playback at normal speed;
a copyright information detection section for detecting the copyright information from the audio data decoded by the decoding section and outputting the detected copyright information; and
an output control section for determining, based on the copyright information detected by the copyright information detection section, whether or not the contents are authorized contents and outputting the output control signal, wherein when the contents have been determined to be authorized contents, the output control section outputs the output control signal so as to make the output section produce an output, and when the contents have been determined to be unauthorized contents, the output control section outputs the output control signal so as to make the output section stop producing an output.

2. The decoding apparatus of claim 1, further comprising a storage section for storing the copyright information detected by the copyright information detection section,
wherein the output control section outputs the output control signal based on the copyright information stored in the storage section.

3. The decoding apparatus of claim 2, wherein when the decoding section performs the decoding process for detecting the copyright information at high speed, the decoding section performs the decoding process in which process for decoding the encoded audio data is partially omitted.

4. The decoding apparatus of claim 3, wherein the decoding section decodes the encoded audio data only for a predetermined period.

5. The decoding apparatus of claim 3, wherein the decoding section decimates the encoded audio data and performs decoding.

6. The decoding apparatus of claim 3, wherein the decoding section decodes only part of multiple channels of data existing as the encoded audio data.

7. The decoding apparatus of claim 3, wherein the decoding section obtains audio data whose sampling frequency is lower than that of audio data obtained when normal process is performed for the encoded audio data.

8. The decoding apparatus of claim 3, wherein the decoding section selects part of the encoded audio data that has been encoded by a method that allows an amount of computation required for decoding to be minimized and then decodes the selected part.

9. The decoding apparatus of claim 2, wherein when there is a playback request, the decoding control section externally outputs a notification of prohibition of high speed playback.

10. The decoding apparatus of claim 2, wherein the output control section outputs, as the output control signal, a signal for prohibiting an output, except when copyright information detected from part of the encoded audio data that has been encoded by at least one encoding method is stored in the storage section.

11. The decoding apparatus of claim 2, wherein the output control section outputs, as the output control signal, a signal for prohibiting an output, when copyright information detected from part of the encoded audio data that is to be played back is not stored in the storage section.

12. The decoding apparatus of claim 1, wherein when the decoding section performs the decoding process for detecting the copyright information at high speed, the decoding section performs the decoding process in which process for decoding the encoded audio data is partially omitted.

13. The decoding apparatus of claim 12, wherein the decoding section decodes the encoded audio data only for a predetermined period.

14. The decoding apparatus of claim 12, wherein the decoding section decimates the encoded audio data and performs decoding.

15. The decoding apparatus of claim 12, wherein the decoding section decodes only part of multiple channels of data existing as the encoded audio data.

16. The decoding apparatus of claim 12, wherein the decoding section obtains audio data whose sampling frequency is lower than that of audio data obtained when normal process is performed for the encoded audio data.

17. The decoding apparatus of claim 12, wherein the decoding section selects part of the encoded audio data that has been encoded by a method that allows an amount of computation required for decoding to be minimized and then decodes the selected part.
